(19) United States
(12) Patent Application Publication
(10) Pub. No.: US 2013/0037375 A1
(43) Pub. Date: Feb. 14, 2013

(54) BUSHING COMPRISING COMPOSITE LAYERS

(71) Applicants: Marco Salazar Jaulhac, San Bernardo (CL); Sebastián Silva Compagnet, San Bernardo (CL)

(72) Inventors: Marco Salazar Jaulhac, San Bernardo (CL); Sebastián Silva Compagnet, San Bernardo (CL)

(73) Assignee: CASAS DEL VALLE BARROS HNOS. LTDA., San Bernardo, Santiago (CL)

(21) Appl. No.: 13/642,774

(22) PCT Filed: Sep. 23, 2011
(86) PCT No.: PCT/IB2011/054206

§ 371 Date: Oct. 22, 2012

(30) Foreign Application Priority Data
Sep. 30, 2010 (CL) 1048-2010

(51) Int. Cl. B65G 11/02

(52) U.S. Cl. 193/2 R

(57) ABSTRACT

The invention discloses a composite layer bushing used as supplementary material feeder in mold cast processes, which decreases the heat loss between the walls thereof and the sand of the mold. The bushing of the invention comprises two concentric layers, an inner exothermic layer and an outer insulating layer, wherein said layers form an upper section corresponding to a hollow cylinder, and a lower section corresponding to the bottom of the bushing.

The present invention is related to the manufacturing industry of cast steel and iron pieces, which are obtained using sand cast molds agglomerated with binders, where the shape of the piece is achieved by using a mold that includes a suitable hollow cast form in the sand. In particular, the present invention consists in a bushing comprising composite layers, used as a supplementary material feeder in cast mold processes, wherein said bushing is used to avoid defects caused by the volumetric contraction of metallic alloys when passing from liquid to solid state.

### BACKGROUND

Most metals and alloys suffer an important volume decrease when passing from liquid to solid. This is known as volumetric contraction. During this solidification process of a cast piece, this volumetric contraction has to be compensated with an additional metal supply. Otherwise, cracks and serious defects occur in the pieces, which are broadly known as shrink cavities or voids.

The liquid metal added to compensate the volume loss described, is provided through one or more cavities present in the mold, known as risers. The most broadly used geometric configuration for making risers is a cylindrical one, with a length to diameter ratio ranging from 1 to 3. These risers can be located over the piece or at a side thereof, depending on the geometry and the available surfaces. The main condition for an effective riser is to contain liquid metal until the end of the piece solidification. For this aim, the riser should have a geometric configuration allowing heat dissipation at a lower rate compared to the heat dissipation from the piece through the casting mold.

Currently, there are commercially available preformed hollow cylinders called bushings that significantly decrease the size of risers, thus decreasing the diameter and height thereof.

The decrease percentage of the metal contained in a riser could attain up to 60% of the metal mass in comparison with a green riser, which is a cylinder made from the same material of the mold, generally sand. This produces a decrease in associated costs, due to a decrease in the amount of sand required for the molds, a lower consumption of refractory materials and lower energy requirements, all this due to a lower riser mass return. Thus, a productivity increase and the like can also be obtained.

Bushings have a thickness in the order of one tenth of the internal diameter and heights of 1 to 3 times the diameter, can have a conical section or can be provided with lids at their top sections. These bushings are called jackets, collars or “riser sleeves”. These preformed pieces are commercialized by identifying their dimensions and application field, expressed as a cooling modulus of the material that can be fed through them (the cooling modulus is defined as the ratio between the volume of the piece and the contact area with the sand in the mold) and the maximum weight of the piece that can be produced without voids. Usually, all manufacturers of these products provide tables with variables to select the optimal product given a specific configuration of piece, alloy, sections, etc.

The most usual procedure to manufacture bushings is to manufacture the product from an aqueous pulp and then centrifuging or applying vacuum suction in a suitable device, which could be a centrifuge having a bucket with the same external dimensions of the bushing or a vacuum device having the same dimensions of the bushing. Once the piece is removed from the mold, it is subjected to drying and binder curing. Another manufacturing procedure consists in using machines that shoot suitable granular mixtures containing Cold Box binders, silicate-CO₂, amine-catalyzed phenolic urethane resins, resol-CO₂, resol methyl formate. Commercial bushings can be insulating or exothermic.

The performance of insulating bushings as feeders is based on their capacity to insulate heat transfer edges. This property is defined by a thermal conductivity, a technical index measured in W/m²K (watts per squared meter and Kelvin degree). Insulating bushings, which have a lower performance in comparison with exothermic bushings, are preferentially used in large volume pieces, in non-ferrous metals such as brasses and bronzes, and as slag collectors in gray and nodular iron melting.

The magnitude of thermal conductivity in a large variety of commercially available bushings ranges between 0.3 to 0.5 W/m²K. The composition of these bushings is based on a mixture of refractory earths and granular powders that conform a low-density (ranging between 0.35 g/cm³ and 0.70 g/cm³) product, with a mechanical strength suitable for manipulation and use.

Exothermic bushings are based not only in their insulating capacity, but also by the fact that they react with the heat supplied by the melted metal and generate plenty of additional heat through an aluminothermy reaction, wherein powdered aluminum contained within the formulation of said bushings reacts in contact with oxidants according to:

2Al+Fe₂O₃→Al₂O₃+2Fe

Reaction rates are controlled as a function of the granulometry and purity of the aluminum and the type of oxidant employed. The manufacture of these bushings is analogous to the manufacture of insulating bushings.

The metal supply capacity of a bushing-coated riser is expressed as the percentage of supplied metal (Kg) in relation to the total metal (Kg) contained in the bushing.

Exothermic bushings supply a maximum of 35% of the metal contained within, whereas insulating bushings supply a maximum of 28% of the metal contained within.

The geometry of the cast pieces influences the bushing supply capacity. To calculate the effect of piece geometry on the feed, the cooling modulus of the piece, expressed in length units, is used. To ensure a suitable feed, the bushing geometric modulus is calculated, which should be higher than the cooling modulus of the piece, with a minimum factor of 25%, that is:

M_{bushing,geometric}=1.25×M_{piece}

In this way, the bushing modulus is calculated increasing the bushing geometric modulus (volume/area) by a factor called extension factor, and the extension factor of exothermic materials is 1.40.

This empirical factor reflects the improvement due to a lower conductivity and the exothermic heat supply.

M_{bushing}=M_{bushing,geometric}×1.4

Bushing manufacturers supply the bushing modulus already increased by the extension factor.

The document WO 01/70431 A1 of the previous art presents mixtures for exothermic and/or insulating bushings that comprise: (1) a bushing composition that comprises hollow stabilized aluminosilicate microspheres, and (2) a chemically reactive binder. Bushings are formed from said mixtures and cured in the presence of a catalyst by means of the COLD-BOX process. An oxidizable metal typically used in this invention is aluminum powder, while the insulating material typically is unreactive hollow aluminosilicate microspheres. In this way, when conditions are suitable, bushings with both exothermic and insulating properties can be produced, wherein for exothermic bushings the weight ratio between aluminum powder and unreactive hollow aluminosilicate microspheres ranges from 1:5 to 1:1, and preferably from 1:3 and 1:1.5.

Although the use of bushings comprising refractory materials, oxidants, insulators, powdered aluminum or resins has introduced improvements with respect to previous technologies (where no bushings were used and risers were made of sand), the fact of homogeneously mixing the components in a single material does not make the process efficient enough, mainly because it does not take any advantage from the individual benefits of the exothermic and insulating materials and from the advantages brought about by the formation of a high temperature barrier in exothermic bushings, losing heat that is absorbed by the sand in the mold that covers the bushing. Furthermore, another disadvantage of the previous art lies in the use of non-optimal geometries, with an even wall thickness that does not compensate for the decrease of the cooling modulus that occurs when metal pass-through cross-sections are decreased.

Consequently, the present invention comprises a bushing that reduces heat losses through its walls to the sand of the mold by the incorporation of an insulating layer between the exothermic layer and the sand, thus increasing the metallic supply capacity of the bushing and at the same time increasing the extension factor thereof, generating in this way an increase in the metal yield in the manufacture of cast pieces.

To produce the desired effects, the invention considers the use of composite layers during the bushing manufacture, with an internal layer with exothermic properties being in contact with the metal and an external layer in contact with the mold sand having insulating properties. If a bushing is configured as a combination of an exothermic layer in contact with the liquid metal and another wall with highly insulating properties in internal contact with the mold sand, heat losses from the exothermic bushing are significantly decreased because the exothermic surface is not in contact with the sand, which has a thermal conductivity of 0.95 W/m²K. When the external wall of the exothermic bushing contacts an insulating material with a conductivity of 0.35 W/m²K, according to the basic heat transfer laws and applying Fourier's law for heat conductivity in solids, a 2.5-fold decrease in heat losses from the inner exothermic bushing can be calculated.

### BRIEF DESCRIPTION OF THE DRAWINGS

FIG. 1 shows a front cross view of a cast system that includes: a feed channel (1), a piece (2), a riser (3), a bushing (4) and a breaking neck (5).

FIG. 2 shows an isometric cross view of the composite layer bushing according to the present invention.

FIG. 3 shows a front cross view of the composite layer bushing according to the present invention.

FIG. 4 shows an exothermic heating curve of the bushing.

FIG. 5 shows the exothermic heating derivative curve of the bushing.

FIG. 6 shows the results obtained with SOLID CAST, comparing (a) an exothermic layer ND 260 bushing and (b) a double layer ND 240 bushing according to the present invention, with an inner exothermic layer and an outer insulating layer.

### DETAILED DESCRIPTION OF THE INVENTION

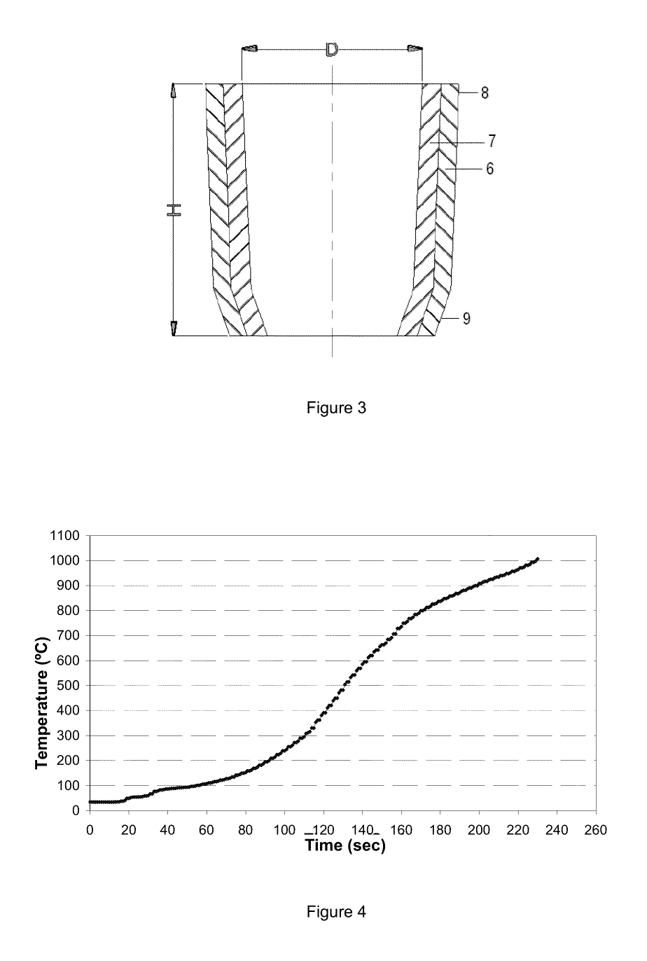

The present invention will be described in detail with reference to FIGS. 2 and 3.

According to the present invention, a composite layer bushing (4) is provided, to be used as feeder of supplementary material in cast molding processes in order to prevent defects caused by the volumetric contraction of metallic alloys. Said bushing (4) comprises two concentric layers, an inner exothermic layer (7) and an outer insulating layer (6), wherein said layers form an upper section (8) corresponding to a hollow cylinder and a lower section (9) corresponding to the bushing bottom (4).

As depicted in FIG. 3, the bushing (4) comprises a hollow cylinder with an internal diameter D, in centimeters, and with a total width (e) of both layers ranges from 0.1 D to 0.1 D plus 2 cm, wherein preferably said width (e) is around 0.1 D plus 1 cm. The bushing also has a height H that ranges from 1.5 D to 2 D, and the diameter D of the invention ranges from 10 cm to 60 cm for any type of alloys.

In a preferred configuration of the invention, the inner layer (7) and outer layer (6) have the same width. However, the width ratio between the inner layer (7) and outer layer (6) can be varied according to design requirements.

Furthermore, in a preferred configuration of the invention, the lower section (9) can be a truncated circular cone with height H′ ranging from 0.3 D to 0.5 D and an internal diameter D′ ranging from 0.5 D to 0.75 D. However, this base could also be cylindrical, with the same D, H and width of the bushing.

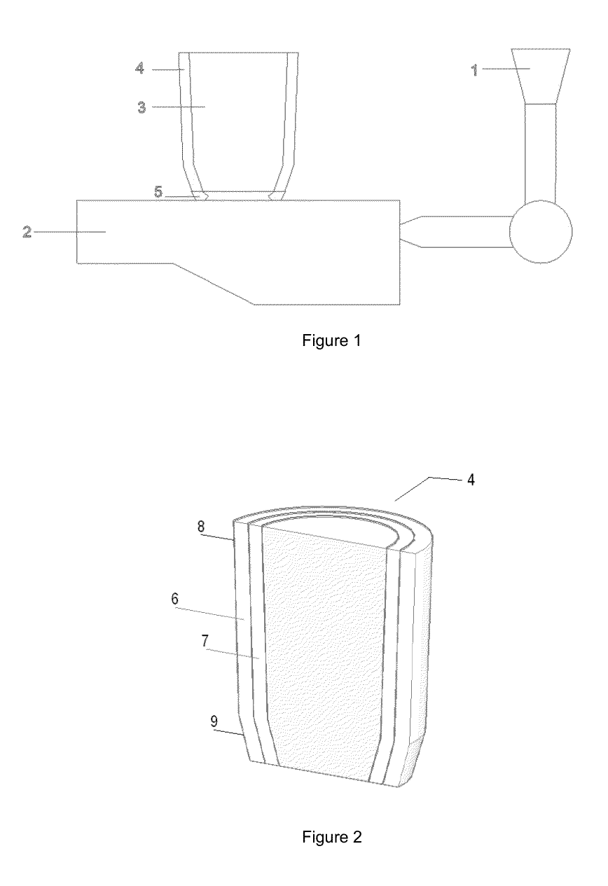

Alternatively, said bushing (4) can comprise breaking, cutting or strangling necks at the bottom thereof, as depicted in FIG. 1.

The bushing (4) of the invention forms a rigid body and the layers that form the bushing are adhered, thus allowing suitable handling of the bushing. Both the inner layer (7) and the outer layer (6) are manufactured with specific granular mixtures agglomerated with cold setting resins and liquid or gaseous catalysts.

The bushing (4) of the present invention is not limited to the use of hollow microspheres, but expanded perlite, expanded vermiculite, ceramic alumina fibers, powdered aluminum, cold setting organic resins or any inorganic binder can be used as well.

Furthermore, the material used for the concentric layers (6, 7) comprises one or more organic resins selected from a group consisting of phenolic urethane resins, ester alkaline resins, and furan resins. Likewise, said concentric layers (6, 7) can comprise one or more inorganic binders selected from a group consisting of ester silicates, and aluminosilicate- or silicate-based refractory hydraulic cements.

According to a preferred configuration of the invention, the ranges used for the formulation of both insulating and exothermic layers are the following:

| Insulating layer | % |
|---|---|
| Silica sand | 15-25 |
| Granular expanded perlite | 10-20 |
| Expanded vermiculite | 5-15 |
| Hollow microspheres | 38-48 |
| Phenolic urethane resin | 7-17 |

| Exothermic layer | % |
|---|---|
| Powdered aluminum | 20-30 |
| Granular expanded perlite | 10-20 |
| Calcium fluoride | 2-8 |
| Iron oxide (hematite) | 2-8 |
| Barium nitrate | 2-8 |
| Hollow microspheres | 25-35 |
| Phenolic urethane resin | 10-20 |

### APPLICATION EXAMPLE

The manufacturing process for these composite layer bushings considers shooting the insulating mixture into a mold provided with an inner piece to form the inner width in a Cold Box-process, subsequently substituting the inner piece by another piece with a lower diameter and then shooting the exothermic mixture in a Cold Box-process.

The width of both exothermic and insulating layers is fixed at the same magnitude for production reasons.

The theoretical basis to calculate the efficiency of double-layer bushings is based on the simulation of solidification using finite elements with the software SOLD CAST and subsequent testing of standard cast cubes.

Both theoretical calculations and empirical testing prove that the configuration of composite exothermic and insulating layers has a higher efficiency in comparison to a single exothermic layer, and therefore to an insulating layer as well.

For the double layer simulation, a reference piece was used (standard prism) with dimensions of 42 cm×42 cm×27 cm (height), with a weight of 360 kg of a chrome and molybdenum alloy having a thermal conductivity of 26.3 W/m° K, a thermal capacity of 454 J/kg° K, a cast temperature of 1,520° C., a solidification temperature of 1,190° C., a solidification range of 50° C. and a latent fusion heat of 267,306 J/kg. The riser of the two-layer bushing is a cylinder having a diameter of 24 cm and a height of 24 cm, and a conical base with a cone height of 12 cm and an inner bottom cone diameter of 17 cm. The weight of the resulting riser is 97 kg of liquid metal.

The bushing has a total width of 3.4 cm, with an inner 1.7-cm exothermic layer and an outer 1.7-cm insulating layer. The thermodynamic properties used for the exothermic width are: thermal conductivity of 0.5 W/m° K, heat capacity of 837 J/kg° K, density of 600 kg/m³, ignition temperature of 400° C., burning time of 1.5 minutes and burning temperature of 1,370° C. The thermodynamic properties of the insulating width are: thermal conductivity of 0.35 W/m° K, heat capacity of 837 J/kg° K and density of 480 kg/m³.

This bushing is compared to a 26 cm-diameter bushing manufactured as a single 3.4 cm-width exothermic layer with the same thermodynamic properties of the exothermic layer used for the two-layer bushing, formed by a cylinder of 26-cm diameter and 26-cm height and a conical bottom section with a cone height of 13 cm and an inner bottom cone diameter of 18 cm. The resulting weight of the riser is 124 kg of liquid metal. The reference piece for comparison is the same for both bushings, both in dimensions and in material.

The thermodynamic properties were assessed in a material burning kinetic test at 1,000° C. The test consists of introducing a thermocouple in a 14×6×1.5 cm test container and connecting said thermocouple to a computer through an interface that records time and temperature to generate characteristic curves.

One of said curves is shown in FIG. 4, corresponding to the exothermic heating curve of the bushing. From this, it is possible to calculate the heat power by calculating the area under the curve, and the burning temperature can be calculated from this value.

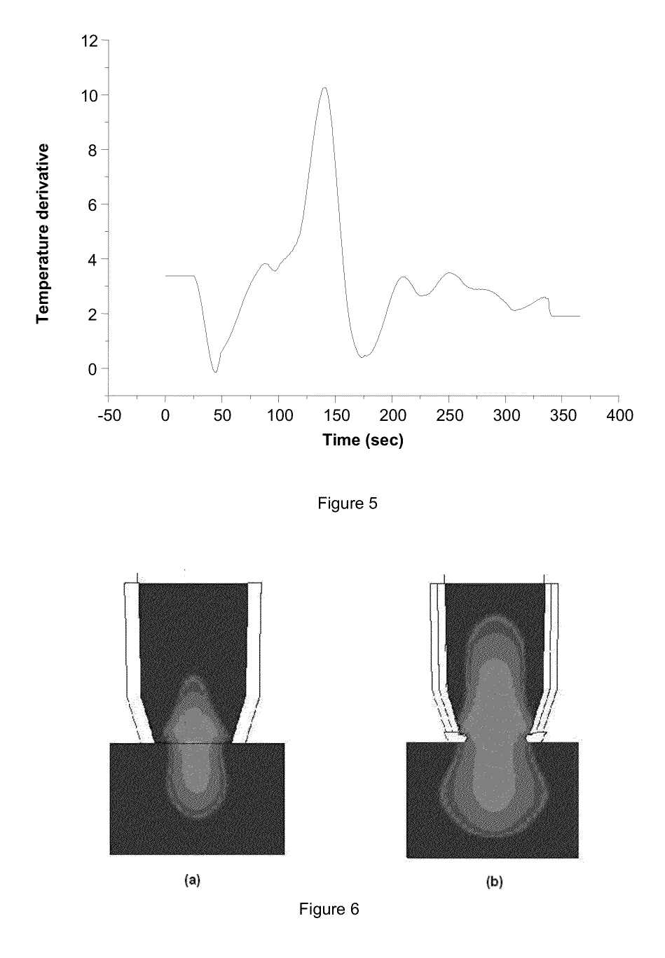

Furthermore, FIG. 5 shows the derivative of temperature with respect to time of the exothermic heating curve of the bushing. The ignition time of the exothermic layer of the bushing and the average heat capacity can be calculated from this curve. The conductivity is obtained by heating a cylinder of the bushing material and determining the equilibrium temperatures.

From the information provided by both curves, optimized values for the heating power, burning temperature and heat conductivity are extracted, which give information about the heat insulating capacity. These values are introduced in the finite element software Solid Cast, using the layers of the invention, and the results for exothermic bushings and two-layer bushings used to feed a standard reference cube are compared. FIG. 6 shows that two-layer bushings keep the metal in the liquid state for longer than an exothermic bushing. This is more clearly seen in the lighter zone, which represents the last fraction of the metal to solidify at last; this zone should be located over the piece. FIG. 6 compares an exothermic layer ND 260 bushing with a metal weight of 124 kg, to a lower-size double layer ND 240 bushing with a metal weight of 97 kg. The ND 240 bushing is better as a feeding device than the ND 260 bushing. Practical assays in industrial casts also prove this conclusion.

The bushing comprising an inner exothermic layer surrounded by an insulator allows keeping the temperature of the aluminothermy reaction for longer, thus avoiding the cooling down of the metal inside the riser, and increasing the metal contributed by the bushing.

Only as a way of example, the following formulations are indicated to be used in the bushing of the invention:

| Component | % |
|---|---|
| Silica sand | 20 |
| Granular expanded perlite | 15 |
| Expanded vermiculite | 10 |
| Hollow microspheres | 43 |
| Phenolic urethane resin | 12 |

An exothermic formulation suitable and tested for the invention is:

| Component | % |
|---|---|
| Powdered aluminum | 25 |
| Granular expanded perlite | 15 |
| Calcium fluoride | 5 |
| Iron oxide (hematite) | 5 |
| Barium nitrate | 5 |
| Hollow microspheres | 30 |
| Phenolic urethane resin | 15 |

Using the formulations for the manufacturing of bushings according to the invention, with two layers of the same width, bushings with improved properties are obtained, which were assessed in the casting of standard prisms with the abovementioned dimensions. These prisms were analyzed with ultrasound, and thus the simulation calculations were experimentally verified. The improvements of the bushing of the invention were compared with a bushing and riser with the same geometric dimensions, considering only an exothermic material with the abovementioned thermodynamic properties.

The extension factor of the bushing modulus is increased from 1.4 to 1.6; therefore, the modulus of the two-layer bushing is 15% larger than that of an exothermic bushing with the same geometry.

The increase of this modulus in the two-layer bushing allows a decrease of the riser sizes, with important metal savings.

The metal contribution of the riser comprising a two-layer bushing is 45%, i.e. 22% more metal contribution in relation to an exothermic bushing with the same width that contributes 35% of the metal contained therein.

1. A composite layer bushing used as supplementary material feeder in mold cast processes, wherein said bushing comprises:
two concentric layers, an inner exothermic layer and an outer insulating layer, said layers forming:
an upper section corresponding to a hollow cylinder; and
a lower section corresponding to the bushing bottom.

2. The bushing according to claim 1, wherein said bushing has an internal diameter D in the upper section and a width considering both layers that ranges from a tenth of the diameter D and a tenth of the diameter D plus 2 cm.

3. The bushing according to claim 2, wherein the width is a tenth of the diameter D plus 1 cm.

4. The bushing according to claim 2, wherein said bushing has a height H ranging from 1.5 D to 2 D.

5. The bushing according to claim 1, wherein the inner and outer layers have the same width.

6. The bushing according to claim 1, wherein the ratio between the widths of the inner and the outer layers is variable.

7. The bushing according to claim 1, wherein the lower section is a truncated circular cone with a height H′ ranging from 0.3 D to 0.5 D and an internal diameter D′ ranging from 0.5 D to 0.75 D.

8. The bushing according to claim 1, wherein the lower section is a hollow cylinder with the same dimensions of the upper section.

9. The bushing according to claim 1, wherein the internal diameter of the upper section ranges between 10 cm and 60 cm.

10. The bushing according to claim 1, wherein the material used for the concentric layers is one or more selected from the group consisting of hollow microspheres, expanded perlites, expanded vermiculites, alumina ceramic fibers, powdered aluminum, cold setting organic resins or inorganic binders.

11. The bushing according to claim 1, wherein the material used for the concentric layers comprises one or more organic resins selected from the group consisting of phenolic urethane resins, ester alkaline resins, furan resins.

12. The bushing according to claim 1, wherein the material used for the concentric layers comprises one or more inorganic binders selected from the group consisting of ester silicates, aluminosilicate- or silicate-based refractory hydraulic cements.

13. The bushing according to claim 1, wherein the material used for the insulating concentric layer is: 15% to 25% silica sand, 10% to 20% granular expanded perlite, 5% to 15% expanded vermiculite, 38% to 48% hollow microspheres and 7% to 17% phenolic urethane resin.

14. The bushing according to claim 1, wherein the material used for the exothermic concentric layer is: 20% to 30% powdered aluminum, 10% to 20% granular expanded perlite, 2% to 8% calcium fluoride, 2% to 8% iron oxide, 2 to 8% barium nitrate, 25% to 35% hollow microspheres and 10% to 20% phenolic urethane resin.
